(19) United States
(12) Patent Application Publication
(10) Pub. No.: US 2006/0291418 A1
(43) Pub. Date: Dec. 28, 2006

(54) Method and system for optimal call routing in GSM foreign mode for CDMA to GSM roaming

(75) Inventor: Lokdeep Singh, Columbia, MD (US)

Correspondence Address: BINGHAM MCCUTCHEN LLP, 3000 K STREET, NW, BOX IP, WASHINGTON, DC, 20007, US

(73) Assignee: International Mobile Communications, Inc.

(21) Appl. No.: 11/157,958

(22) Filed: Jun. 22, 2005

(51) Int. Cl. H04J 3/22; H04J 3/16; H04Q 7/24; H04Q 7/00

(52) U.S. Cl. 370/331; 370/338; 370/466

(57) ABSTRACT

The present invention allows for optimal late call forwarding between dissimilar cellular technologies. A call forwarding mapping function (“CFMap”) is performed to modify the call forward to number from a home cellular network, such as a CDMA and TDMA network to a call forward number for a visited cellular network. The ISDN User Part (“ISUP”) forward leg of a late call forwarding call is handled after late call forwarding is invoked and control of the late call forwarding call is passed back to the home cellular network.

### BACKGROUND OF THE INVENTION

1. Field of the Invention

The present invention relates to a method, a system and a computer program product for providing optimal routing for late call forwarding to voice mail systems. More particularly, the present invention relates to a method, a device and a computer program product for providing optimal call routing for late forwarding between dissimilar cellular technologies.

2. Description of the Prior Art

The TIA/EIA J-038 standard defines how roaming is to be implemented between dissimilar cellular technologies, such as Time Division Multiple Access (“TDMA”), Code Division Multiple Access (“CDMA”), and Global System for Mobile (“GSM”) cellular technologies. The standard, however, does not specify how to implement call delivery to the home voice mail system of a cellular network subscriber, such as a CDMA or TDMA network subscriber, roaming in another cellular network, such as a GSM network. The dissimilar implementation of voice mail in CDMA/TDMA network subscriber (“ANSI”) and GSM networks and the non-implementation of optimal routing on most GSM networks makes call delivery to home voice mail of CDMA/TDMA subscribers roaming in a GSM network more difficult. Existing voice mail solutions for inter-network roaming have limitations where the call to voice mail includes two international/long distance calls. The placing of two international or long distance calls each time late call forwarding is performed when a CDMA/TDMA subscriber is roaming in a GSM network increases the cost of service to the CDMA or GSM subscriber.

Accordingly, there is a need for a method, system, and computer program product for performing optimal late call forwarding. There is a need for the method, system, and computer program product to perform the optimal late call forwarding between dissimilar inter-network cellular technologies. There is a need for the method, system, and computer program product to reduce the cost associated with late call forwarding between dissimilar inter-network cellular technologies. There is a need for the method, system, and computer program product to perform late call forwarding without placing two international or long distance calls.

### SUMMARY OF THE INVENTION

According to embodiments of the present invention, a method, system, and a computer program product for performing optimal late call forwarding are provided. The method, system, and computer program product implements a call forwarding mapping function (“CFMap”) to modify the call forward to number from a home cellular network, such as a GSM, CDMA and TDMA network. The method, system, and computer program product handles the ISDN User Part (“ISUP”) forward leg of a late call forwarding call after late call forwarding is invoked and passes control of the late call forwarding call back to the home cellular network.

In an embodiment of the present invention, the method, system and computer program product receives an incoming call related signaling messages for a home cellular network subscriber roaming in a visited cellular network, determines whether the late call forwarding has been invoked by the visited network, where the incoming call was not answered; and if so, determines the call reference number used for the incoming call, such as a call reference used in GSM MAP message Provide Roaming Number, transmits a request to redirect the incoming call to home cellular network with the re-direction reason, which then routes the incoming call to the voicemail box of the home cellular network subscriber using the default call forward number of the home cellular network subscriber as the called party address.

In an embodiment of the present invention, the method, system and computer program product further includes authenticating the home cellular network subscriber in the visited cellular network.

In an embodiment of the present invention, the method, system and computer program product further includes registering the home cellular network subscriber in a visited cellular network.

### BRIEF DESCRIPTION OF THE DRAWINGS

The above described features and advantages of the present invention will be more fully appreciated with reference to the detailed description and appended figures in which:

FIG. 1 depicts an exemplary functional block diagram of a system in which the present invention can find application;

FIG. 2 depicts an exemplary flow diagram for performing optimal call routing for late forwarding between dissimilar cellular technologies according to an embodiment of the present invention; and

FIG. 3 depicts an exemplary flow diagram for performing the CFMap function according to an embodiment of the present invention.

### DETAILED DESCRIPTION OF THE INVENTION

The present invention is now described more fully hereinafter with reference to the accompanying drawings that show embodiments of the present invention. The present invention, however, may be embodied in many different forms and should not be construed as limited to embodiments set forth herein. Appropriately, these embodiments are provided so that this disclosure will be thorough and complete, and will fully convey the scope of the present invention.

According to embodiments of the present invention, a method, system, and a computer program product for performing optimal late call forwarding are provided. The method, system, and computer program product implements a call forwarding mapping function (“CFMap”) to modify the call forward number received from a home cellular network, such as a CDMA and TDMA network. The method, system, and computer program product handles the ISDN User Part (“ISUP”) forward leg of a late call forwarding call after late call forwarding is invoked and passes control of the late call forwarding call back to the home cellular network. The ISUP is used to set up and tear down all circuits used for data or voice calls in the Public Switched Telephone Network. In an embodiment of the present invention, the ISUP establishes trunk connections between switching centers.

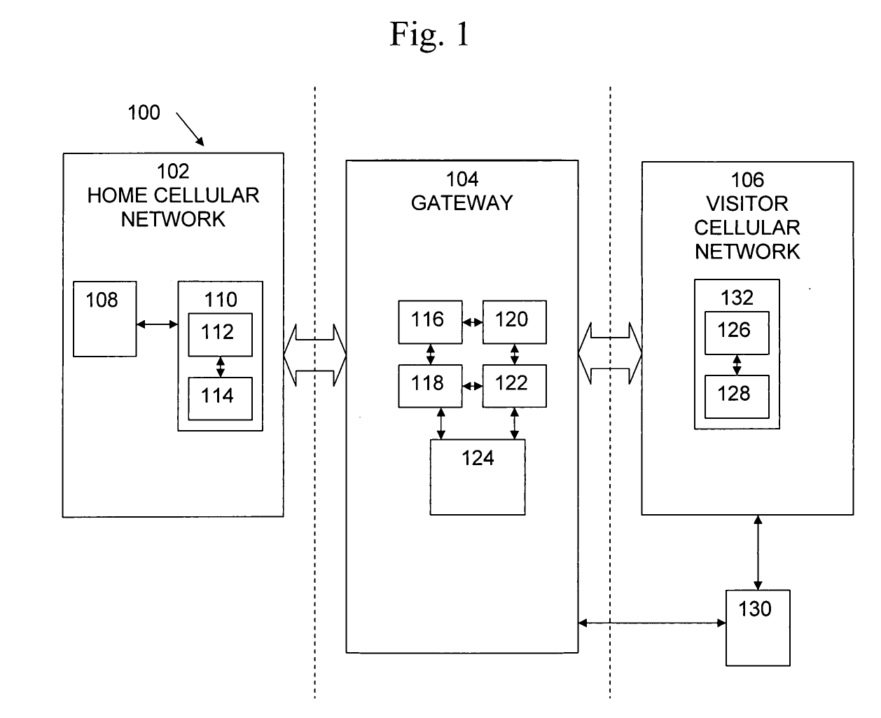

FIG. 1 depicts a functional block diagram of a system in which the present invention can find application. In the embodiment of FIG. 1, system 100 can be implemented to provide optimal call routing for late forwarding between dissimilar cellular technologies. In the FIG. 1 embodiment of the present invention, system 100 includes home cellular network 102, roaming gateway 104, visited cellular network 106.

In the FIG. 1 embodiment of the present invention, home cellular network 102 includes, but is not limited to, voicemail system 108 and home network system 110. In an embodiment of the present invention, home cellular network 102 covers a specific geographical region and implements CDMA cellular network technology. In an embodiment of the present invention, home cellular network covers a specific geographical region and implements TDMA cellular network technology.

In the FIG. 1 embodiment of the present invention, voicemail system 108 receives a late call forwarding incoming call when a home network subscriber does not answer an incoming call and routes the incoming call to a voicemail box of the home cellular network 102 subscriber using the subscriber's number as the called party address. In the FIG. 1 embodiment of the present invention, a home network system 110 couples to the voicemail system 108 and includes a home network home location register 112 and a home network mobile switching center 114.

In the FIG. 1 embodiment of the present invention, the home network home location register 112 receives a Mobile Application Part (“MAP”) REGNOT message used for requesting initial registration between and within CDMA and/or TDMA networks and a MAP TRANSNUMREQ message used by a home network technology compliant visitor location register to request a call forward number from home network technology compliant home location register including a redirect reason, such as Call Forward Busy (“CFB”) or Call Forward No Answer (“CFNA”), and transmits a REGNOT acknowledge message including an indication that CFB/CFNA is active, a TRANSNUMREQ acknowledged message with the CFB/CFNA forward to number, and a MAP ROUTREQ message to roaming gateway 104 using the Mobile Switching Center ID of the roaming gateway 104.

In an embodiment of the present invention, the home network subscriber is roaming in visited cellular network 106 in foreign mode. In an embodiment of the present invention, the CFB/CFNA number is provided as a non-E164 number and includes a prefix and a MDN, such as 11+MDN. An E164 number is a number under the international public telecommunication number plan. The format is Country Code (“CC”)—National Destination Code (“NDC”)—Subscriber Number (“SN”). MDN is the dialable number of home cellular network subscriber, including three digit area code and seven digit phone number.

In the FIG. 1 embodiment of the present invention, the home mobile switching center 114 receives an incoming ISDN User Part (“ISUP”) call for a subscriber of the home cellular network 102 and a home network technology compliant MAP REDREQ message with a re-direct reason, transmits a home network technology compliant MAP TRANSNUMREQ message to the home network location register, obtains the CFB/CFNA forward to number, acknowledges the REDREQ, and initiates and releases an ISUP call setup procedure that was initiated using a telephone number as the called party address in the ISUP IAM message. In an embodiment of the present invention, the telephone number is a Temporary Local Directory Number (“TLDN”). In an embodiment of the present invention, the telephone number is a Mobile Subscriber Roaming Number (“MSRN”).

In the FIG. 1 embodiment of the present invention, roaming gateway 104 includes a home network technology compliant visitor location register 116, a home network technology compliant mobile switching center 118, a visited network technology compliant home location register 120, a visited network technology compliant mobile switching center 122 and a visited network technology compliant authentication center 124. In the FIG. 1 embodiment of the present invention, roaming gateway 104 enables a subscriber of home network 102 to receive and place telephone calls in visitor network 104 once the subscriber of home network 102 has been authenticated and registered by roaming gateway 104.

In the FIG. 1. embodiment of the present invention, roaming gateway 104 receives an Update Location Request, translates the Update Location Request to a home network technology compliant REGNOT and transmits the home network technology compliant REGNOT to home network 102. In an embodiment of the present invention, the Update Location Request includes the International Mobile subscriber Identity (“IMSI”). In an embodiment of the present invention, the roaming gateway 104 is acting as the home network technology compliant visitor location register 116 when transmitting the home network technology compliant REGNOT.

In the FIG. 1 embodiment of the present invention, the roaming gateway 104 receives a REGNOT ACK from the home network 102, transmits the home network subscriber's profile to the visitor network 106, and receives an acknowledgement from the visitor network 106 that the home network subscriber's profile was received. In an embodiment of the present invention, the CFB/CFNA is marked active in the REGNOT ACK.

In the FIG. 1 embodiment of the present invention, checks for the support of TRANSNUMREQ by home network 102 in the configuration in response to a determination that CFB is marked active, transmits a TRANSNUMREQ message to the home network 102, and receives a TRANSNUMREQ message from home network 102 with the CFB/CFNA forward to number. In an embodiment of the present invention, the CFB/CFNA forward to number is provided as a non E164 number have a format, such as a prefix and a MDN. For example, the CFB number can be provided as 11+MDN. In an embodiment of the present invention, Redirect is specified as call forward busy.

In the FIG. 1 embodiment of the present invention, the roaming gateway 104 implements a CFMap function that maps the non E164 CFB number to an E164 CFB number belonging ISR-OCR system 130, transmits a message that includes, but is not limited to, the E164 CFB number to the visitor network 106, receives an acknowledgement from the visitor network 106 that the message with the E164 CFB number was received, and transmit an acknowledgement to the visitor network 106 that registration of the home network subscriber is complete. In an embodiment of the present invention, CFB is designated as active. In an embodiment of the present invention, the remapped CFB number of the home network subscriber is the E164 CFB number of the ISR-OCR system 130.

In the FIG. 1 embodiment of the present invention, when home network 102 receives an incoming call for the home network subscriber roaming in visitor network 106, the roaming gateway 104 receives a home network technology compliant MAP ROUTREQ message from home network 102, maps the ROUTREQ to a visited network technology compliant 106 Provide Roaming Number or similar message, transmits the Provide Roaming Number message to the visited network 106 to get the mobile subscriber roaming number for routing the call to the visited network and the visited network technology compliant mobile switching center 122. The Gateway MSC address is set to the address of roaming gateway 104 to indicate the support of optimal routing by roaming gateway 104. In an embodiment of the present invention, the ISR-OCR system 130 keeps track of the call reference number used for each Provide Roaming Number Request so that the correct call reference number can be used while generating Resume call handling by ISR-OCR system 130. The call reference number is a field in the provide roaming number message used to indicate the support of optimal call routing.

The roaming gateway receives a Mobile Subscriber Roaming Number (“MSRN”) assigned by visited network 106 for routing incoming calls to home network subscriber roaming in visited network 106 from visitor network 106 in response to the Provide Roaming Number message and provides a Temporary Local Directory Number assigned by visited network 106 for routing incoming calls to home network subscriber roaming in visited network 106 in response to the home network's 102 MAP ROUTREQ message. In the FIG. 1 embodiment of the present invention, roaming gateway 104 maps a visitor network 106 Resume Call Handling Message to a home network REDREQ message and transmits the REDREQ message to home network with the re-direction reason.

In the FIG. 1 embodiment of the present invention, the ISR-OCR system 130 receives call forwarded leg of the call upon invocation of late call forwarding by the visited network when an incoming call received by visited network 106 is not answered by home network subscriber roaming in visited network 106, determines the corresponding call reference number generate during the handling the incoming call(Provide Roaming Number) and transmits the roaming gateway 104 Resume Call Handling message with the correct call reference number. Roaming gateway, in response, maps the 106 Resume Call Handling Message received from ISR-OCR 130 to a home network technology compliant MAP REDREQ message and transmits the REDREQ message to home network with the re-direction reason.

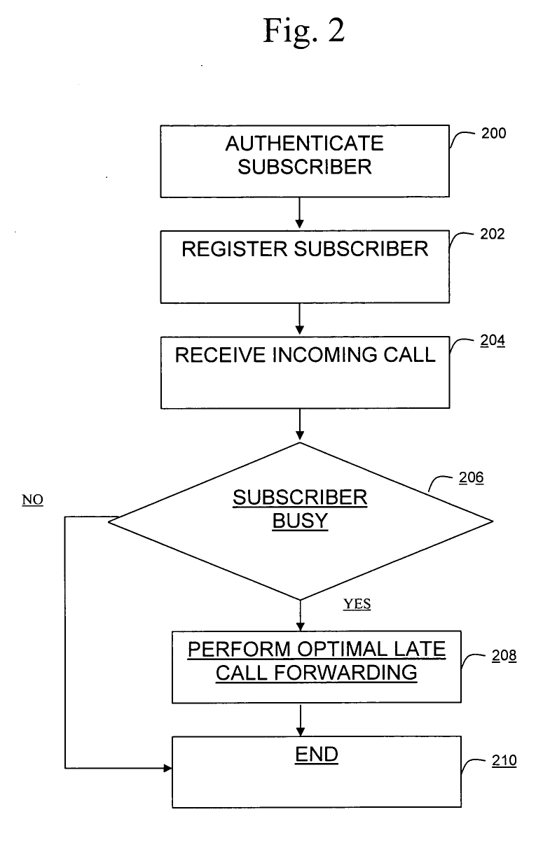

An exemplary flow diagram of an embodiment for providing optimal call routing for late forwarding between dissimilar cellular technologies is shown in FIG. 2. FIG. 2 is best understood when read in combination with FIG. 1. As shown in FIG. 2, the process begins with step 200, a subscriber of home network 102 in visitor network 106 foreign Mode successfully authenticates with gateway 104.

In step 202, the home network 102 subscriber is registered with the visitor network 106 employing roaming gateway 104. In an embodiment of the present invention registration includes, but is not limited to, roaming gateway 104 receiving an Update Location Request, translating the Update Location Request to a home network REGNOT, transmitting the REGNOT to home network 102, receiving a REGNOT ACK from the home network 102, transmitting the home network subscriber's profile to the visitor network 106, receiving an acknowledgement from the visitor network 106 that the home network subscriber's profile was received, checking for the support of TRANSNUMREQ by home network 102 in the configuration in response to determining that CFB is marked active, receiving a CFB number from home network 102, performing a CFMap function that maps the CFB number to an E164 CFB number belonging ISR-OCR system 130, transmitting the E-164 CFB number to the visitor network 106, receiving an acknowledgement from the visitor network 106 that the E164 CFB number was received, and transmitting an acknowledgement to the visitor network 106 that registration of the home network subscriber is complete. Once registered the home network subscriber can receive incoming calls and if busy or call is not answered, have late call forwarding performed. Late call forwarding includes, the called party being on another call and does not answer the incoming call, and failure to answer an incoming call.

In step 204, an incoming call is received at home network 102 for the home network subscriber roaming in visitor network 106. Receiving an incoming call includes, but is not limited to, the roaming gateway 104 receiving a MAP ROUTREQ message from home network 102, mapping the ROUTREQ to a visitor network 106 Provide Roaming Number message, generating a call reference number and setting the GMSC address to the address of roaming gateway 104 to indicate the support of optimal routing by roaming gateway 104.

In step 206, it is determined whether home network subscriber is busy. In an embodiment of the present invention, a busy home network subscriber includes, but is not limited to, a home network subscriber who does not answer an incoming call. If not, the method ends at step 210. If so, the method proceeds to step 208

In step 210, optimal late call forwarding is invoked. In the FIG. 2 embodiment of the present invention, optimal late call forwarding includes, but is not limited to, the ISR-OCR system 130 receives late call forwarding incoming call when an incoming call received by visitor network 106 is not answered by home network subscriber roaming in visitor network 106, determines the corresponding call reference number for the incoming call, and transmits the roaming gateway 104 Resume Call Handling message with the correct call reference 104. Roaming gateway, in response, maps the 106 Resume Call Handling Message received from ISR-OCR 130 to a home network compliant technology REDREQ message and transmits the home network compliant technology REDREQ message to home network with the re-direction reason.

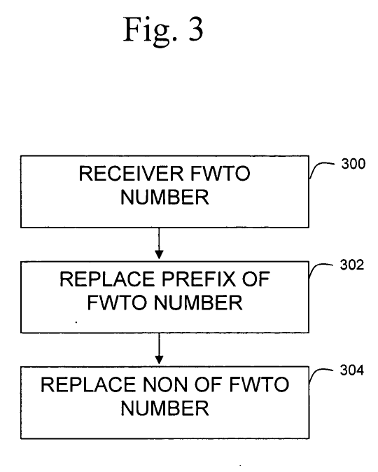

An exemplary flow diagram of an embodiment for performing a CFMap function that maps a non-E164 CFB number to an E164 CFB number belonging to ISR-OCR system 130 is shown in FIG. 3. The CFMap function makes sure that the forwarded leg of the call passes through the ISR-OCR for further call handling in order to implement automatic voice mail delivery to home network subscriber's voicemail box. In step 300, an FWTO number [Note to inventor—what is this] received in “TRANSNUMREQ” response to an E164 address for ISR-OCR system 130. In step 302, a prefix associated with the FWTO number is replaced with a predetermined prefix or a predetermined new number. In step 304, replace the NON of the FWTO number. NON is the nature of number used in ANSI networks to indicate if the number is local, national or international to an international NA (“nature of address”) used in ITU networks to indicate if the number is local, national or international. In an embodiment of the present invention, the CFMap function is performed using a best match algorithm to ensure that we replace ONLY the Voice mail routing Number (CFD number) by the E164 number for the Voicemail Platform for a given MSCID. In an embodiment of the present invention, call forward numbers directly activated by users, such as through USSD and REG_SS [Note to inventor—what are these—USSD is the unstructured supplementary services data used in GSM network for supplementary service control using specific service codes. REG_SS is GSM MAP messages used for subscriber control of supplementary services when USSD is not used], are not overwritten by the CFMap function defined FWTO numbers.

While specific embodiments of the present invention have been illustrated and described, it will be understood by those having ordinary skill in the art that changes can be made to those embodiments without departing from the spirit and scope of the invention.

What I claim is:

1. A method of performing optimal late call forwarding between dissimilar cellular network technologies, the method comprising:
receiving an incoming call for a home cellular network subscriber roaming in a visited cellular network;
determining whether late call forwarding has been invoked by the visited cellular network;
if so, initiating a call to a call forward number in international format for the visited cellular network; determining a call reference number for the incoming call, transmitting a request to redirect the incoming call to home cellular network with the re-direction reason, and routing the incoming call to the voicemail box of the home cellular network subscriber using the home call forward number of the home cellular network subscriber as the called party address; wherein the routing is performed by the home cellular network.

2. The method according to claim 1, further comprising authenticating the home cellular network subscriber in the visited cellular network.

3. The method according to claim 2, further comprising registering the home cellular network subscriber in the visited cellular network.

4. The method according to claim 1, wherein the home cellular network implements one of: CDMA cellular technology and TDMA cellular technology.

5. The method according to claim 4, wherein the visited cellular network implements GSM cellular technology.

6. The method according to claim 1, further comprising mapping the home call forward number of the home cellular network subscriber to the call forward number in international format for the visited cellular network.

7. The method according to claim 6, wherein the home call forward number is in a non-E164 format.

8. The method according to claim 7, wherein the call forward number in international format is in a E164 format.

9. A system for performing optimal late call forwarding between dissimilar cellular network technologies, the system comprising:
a first cellular network implementing a first type of cellular technology operable to:
receive an incoming call for a home cellular network subscriber roaming in a visited cellular network, and route the incoming call to a voicemail box for the home cellular network subscriber using a home call forward number of the home cellular network subscriber as the called party address;
a second cellular network implementing a second type of cellular technology operable to:
determining whether the home cellular network subscriber is busy,
and if so, initiating a call using a call forward number in international format for the visited cellular network;
a first system operable to determining a call reference number used for the incoming call; and
a second system operable to transmit a request to redirect the call to the voicemail of home cellular network with the re-direction reason.

10. The system according to claim 9, further comprising the second system operable to authenticate the home cellular network subscriber in the visited cellular network.

11. The system according to claim 10, further comprising the second system operable to register the home cellular network subscriber in a visited cellular network.

12. The system according to claim 9, wherein the home cellular network implements one of: CDMA cellular technology and TDMA cellular technology.

13. The system according to claim 12, wherein the visited cellular network implements GSM cellular technology.

14. The system according to claim 9, further comprising the second system operable to map the home call forward number of the home cellular network subscriber to the call forward number in international format.

15. The system according to claim 14, wherein the home call forward number is in a non-E164 format.

16. The system according to claim 15, wherein the call forward number as received during registration is in a E164 format.
